(19) United States
(12) Patent Application Publication
(10) Pub. No.: US 2023/0111129 A1
(43) Pub. Date: Apr. 13, 2023

(54) A NON-SENSITIZING ANTIMICROBIAL COMPOSITION FOR WATERBORNE COATING COMPOSITIONS

(71) Applicant: PERSTORP AB, Persrorp (SE)

(72) Inventors: David LÖF, Vellinge (SE); Stefan LUNDMARK, Farhult (SE); Håkan BJÖRNBERG, Malmö (SE)

(21) Appl. No.: 17/904,625

(22) PCT Filed: Feb. 18, 2021
(86) PCT No.: PCT/SE2021/050137

§ 371 Date: Aug. 19, 2022

(30) Foreign Application Priority Data
Feb. 27, 2020 (SE) 2030058-8

(51) Int. Cl. A01N 37/02; A01N 59/00; A01N 25/10; A01P 1/00; C09D 131/04

(52) U.S. Cl. CPC A01N 37/02; A01N 59/00; A01N 25/10; A01P 1/00; C09D 131/04

(57) ABSTRACT

An antimicrobial composition for use as a preservative for waterborne coating compositions where said antimicrobial composition comprise at least two organic compounds in combination selected from a combination of compound group i) and compound group ii). Compound group i) is selected from the group consisting of dodecanoic acid, metal dodecaonoate, ammonium dodecanoate and a combination thereof, while compound group ii) is selected from the group consisting of propionic acid, metal formate, metal propionate, ammonium propionate and a combination thereof. The waterborne coating composition is based on an emulsion polymer resin based on a radical polymerization polymer selected from the group consisting of; vinyl acetate (PVA) polymer, vinyl acetate/ethylene (VAE) copolymer, vinyl acrylic copolymer, acrylic polymer, styrene acrylic copolymer, vinyl acetate/ethylene/vinyl chloride copolymer, vinyl acetate versatate and combinations thereof. The antimicrobial composition constitutes 0.3-3.0% by weight of the coating composition.

The present invention relates to an antimicrobial composition intended for use in waterborne coating compositions and in facilities producing such coating compositions.

### FIELD OF THE INVENTION

Coating compositions, also known as paints, have gone through a radical change over the last couple of decades. In some parts of the world this change is still ongoing. The aim to reduce the amount of organic solvents used in coatings have led to radically increased use of waterborne coating compositions. The reduction of volatile organic compounds (VOC) i.e. organic solvents in coatings have led to increased problems with microbial activity in paint cans. Many can report that a previously opened can of paint will have to be disposed of as a microbial contamination caused by for example of bacteria or mold has infected the paint. One known way of solving this well-known issue is to include an antimicrobial agent. Among the most well-known agents in use can be mentioned isothiazolinones such as methylisothiazolinone (MIT), benzisothiazolinone (BIT) and chloromethylisothiazolinone (CMIT). Although very effective, these antimicrobials have become questioned lately as they are known to be sensitizing substances. This will of course lead to allergic reactions caused by long term exposure and since the above mentioned antimicrobials can be found also in many personal care and household products such an allergy can become rather challenging.

Not only do the increased use of water as sole solvent in coating compositions create problem for the end user, it also creates problems in the manufacturing lines. Here hygiene has become an increased focus area as remaining microbial contamination forming a biofilm in the rather complex make-up of the production apparatus can remain for years and cause bigger problems than ordinary man could conceive. Introduction of antimicrobial agents will of course counteract microbial growth but the sensitizing antimicrobials will end up in the coating composition and may accordingly affect the end user.

### DETAILED DESCRIPTION OF THE INVENTION.

The invention relates to an antimicrobial composition for use as a preservative for waterborne coating compositions. The invention is characterized in that said antimicrobial composition comprise at least two organic compounds in combination selected from a combination of compound group i) and compound group ii).

Compound group i) is selected from the group consisting of dodecanoic acid, metal dodecaonoate, ammonium dodecanoate and a combination thereof.

Compound group ii) is selected from the group consisting of propionic acid, metal formate, metal propionate, ammonium propionate and a combination thereof.

The waterborne coating composition is based on an emulsion polymer resin, said emulsion polymer resin is based on a radical polymerization polymer selected from the group consisting of vinyl acetate (PVA) polymer, vinyl acetate/ethylene (VAE) copolymer, vinyl acrylic copolymer, acrylic polymer, styrene acrylic copolymer, vinyl acetate/ethylene/vinyl chloride copolymer, vinyl acetate versatate and combinations thereof. Said antimicrobial composition constitutes 0.3-3.0% by weight of the coating composition, including water diluent.

According to one embodiment of the invention the antimicrobial composition comprises 0.5-2.5% by weight of the coating composition, including the water diluent.

According to another embodiment of the invention the antimicrobial composition comprises 0.7-2.2% by weight of the coating composition, including the water diluent.

According to a preferred embodiment of the invention the antimicrobial composition comprises;

a) 30 parts per weight of compound group i) and,

b) 5-50 parts per weight of compound group ii), and,

c) optionally an hydroxide selected from the group consisting of, an alkali metal hydroxide and ammonium hydroxide and combinations thereof for pH-adjustment into the range pH 6-9. The pH is suitably adjusted into the range pH 7.5-9.

The metal of said metal dodecaonoate is preferably selected from the group consisting of; sodium, potassium, calcium, magnesium and zinc.

The metal of said metal propionate is preferably selected from the group consisting of, sodium, potassium, calcium, magnesium and zinc.

The antimicrobial composition may according to a special embodiment of the invention further comprise 0.005-0.1 part per weight of a corrosion inhibitor selected from the group consisting of, metal metasilicate, zinc phosphate, calcium phosphate or combinations thereof.

The antimicrobial composition is advantageously added to the coating composition before adding further coating components, said components including pigments, rheologic modifiers and dispersing agents.

The antimicrobial composition is in accordance to one embodiment of the invention added in an amount of 0.1-3% by weight and is utilized for reducing microbial contamination inside a process equipment used for producing said coating compositions.

The antimicrobial composition according to the invention is primarily utilized for reducing microbial contamination and extending shelf life on coating compositions.

In a special embodiment of the invention the antimicrobial composition further comprises a corrosion inhibitor selected from the group consisting of; metal metasilicate, zinc phosphate, calcium phosphate, or combinations thereof. As an alternative or complement to the above described corrosion inhibitors smaller amounts, such as 0.002 to 5% by weight, of the antimicrobial composition can be constituted of zinc dodecanoate and/or zinc propionate.

The reason to need for a corrosion inhibitor is highly varying. Indeed plastic cans and coated metal cans are the predominant container used for waterborne compositions nowadays but sometimes metal fittings, nails and screws are present on the substrate to be painted. These may under certain conditions then corrode and leave unsightly rust stains on the painted surface. Another reason is of bigger importance and one will need to understand the value chain of coating compositions. Accordingly, first a binder resin is produced. There are many types of such known resins, some of them disclosed on following pages of this invention. Since these are waterborne, they are also subject to microbial activity such as fungi, bacteria and mildew. This is, as described earlier, not only a problem in paint cans but also in the production facility. The binder resin only constitutes a part of the final coating composition but is yet subject to microbial activity. There is accordingly reason to add an antimicrobial composition in accordance with the invention early in the process of producing a coating composition. These are however sensitive, different for different resin types, so there is an upper limit to how much can be added not to negatively affect the properties of the resin in question. Knowing that in some coating compositions only about 20% is constituted by the resin binder, one realizes that in many cases antimicrobial agents may have to be added both before and after mixing the final components, such as coalescing agents, rheologic modifiers, pigments, pigment dispersing agents and fillers just to mention a few of commonly used components used in a coating composition. In the beginning of this passage we discussed the possible need for corrosion inhibitors. Since the production apparatus including mixing vessels, pipes, pumps, agitators etc. in most cases are made of steel, it does become important to make sure that the specific production apparatus is not corroded by the antimicrobial agents. Not only will the useful life and function of the equipment be affected also the coating composition may be discoloured.

As discussed above said antimicrobial composition is suitably added to the formulated and reacted polymer resin before adding further coating additives, said additives including pigments, fillers, rheologic modifiers and dispersing agents. The antimicrobial composition is then added in an amount of 0.1-3% by weight and is utilized for reducing microbial contamination inside a process equipment used for producing said coating compositions. The 0.1-3% is may suitably be calculated on a final coating composition, i.e. including the pigments, fillers, rheologic modifiers, dispersing agents and other additives. In some coating compositions only 20% of the final coating composition is constituted by the polymer resin. It is however necessary in all cases to adapt the amount of antimicrobial composition in accordance with the present invention so that it does not affect the final results in a negative way. It is however both possible and advantageous to add sufficient amounts i.e. in the range 0.1-3.0% already when synthesizing the polymer resin in order to obtain a good control of hygiene in the manufacturing. More of the antimicrobial composition according to the present invention can be added at later stages when further components such as pigments, fillers, rheologic modifiers, dispersing agents and other additives are added, thus diluting the antimicrobial composition added from the start. All in order to keep the level of antimicrobial

As discussed above said antimicrobial composition is utilized for reducing microbial contamination and extending shelf life on coating compositions. This can be made regardless of whether antimicrobial composition in accordance with the invention has been added in earlier stages of the process or not. It is well known that some coating producers have indeed managed to keep a strict hygiene regime in their production apparatus without having to relate on antimicrobials.

A series of experiments were performed with different types of coating compositions, subjected to different microbiota and treated with a different antimicrobial compositions in accordance with the present invention. The results are very positive and a radical reduction of microbial contamination on coating compositions have been achieved.

### Experimentation

A typical coating binder resin of vinyl acetate/ethylene (VAE) copolymer type were synthesized and were mixed with typical amounts of additives but was made without adding any of the classically used isothiazolinones. The obtained coating compositions were then mixed with amounts of sodium formate (SoFo), sodium propionate (SoPr) and dodecanoic acid (C12) respectively as defined in table 1. Samples were arranged in anaerobic vials and inoculated with test organism: Pseudomonas aeruginosa, ATCC 10145. Also as specified in table 1, three samples without adding any antimicrobials were prepared, of which two, test No. 5 and 7 (positive reference) were inoculated with Pseudomonas aeruginosa and the remaining test No. 8 were not. These three samples i.e. No. 5, 7 and 8 were all made for comparison. All samples were checked for growth at 5 and 21 days after inoculation. Also ATP levels were measured at 5 and 21 days after inoculation (ATP (Adenosine Triphosphate) measurements: test and method developed by LuminUltra®.). After day 21 the samples were again inoculated with Pseudomonas aeruginosa and after another 9 days the samples were checked for growth and ATP levels. The results are presented in Table 1.

TABLE 1

| | | | | | | ATP |
|---|---|---|---|---|---|---|
| | | | | | | <500 excellent |
| Test | | SoFo | SoPr | C12 | | 500-1000 acceptable |
| No. | comment | (weight %) | (weight %) | (weight %) | ocular | >1000 poor |
| 1 | Test | 2 | | | growth | 4.946 |
| 2 | Test | 1 | | 1 | no growth | 85 |
| 3 | Test | | 2 | | growth | 21.179 |
| 4 | Test | | 1 | 1 | no growth | 69 |
| 5 | pos ref | | | | growth | 4.799 |
| 6 | Test | 1 | 1 | | growth | 5.578 |
| 7 | pos ref | | | | growth | 16.720 |
| 8 | neg ref | | | | growth | 32.990 |

As seen in test example 2 and 4 the results are excellent when sodium formate & dodecanoic acid or sodium propionate & dodecanoic acid respectively have been used in combination. The individual components or sodium formate in combination with sodium propionate did not have sufficient antimicrobial effect. The test also shows the importance of hygiene and how susceptible a waterborne coating composition is to unwanted microbial activity. Samples 5, 7 and 8 were free from antimicrobial additives which shows as growth both by ocular inspection and though ATP measurement. We note especially that, although measures were taken to keep a strict hygiene during every step of the handling, sample number 8, which was not inoculated with Pseudomonas aeruginosa, show a very high level of infection. Our theory is that the sample 8 have been infected with some yet unidentified wild-strain microorganism. The conclusions we draw from the experimentation is that antimicrobial agents are indeed essential in waterborne coatings. It also shows that harmful isothiazolinones commonly used today, can be replaced with more benign and environmentally friendly compositions in accordance with the present invention.

1-11. (canceled)

12. An antimicrobial composition comprising:
(i) a compound selected from dodecanoic acid, metal dodecaonoate, ammonium dodecanoate, and a combination thereof; and
(ii) a compound selected from propionic acid, metal formate, metal propionate, ammonium propionate, and a combination thereof.

13. The antimicrobial composition of claim 12 comprising:
(i) 20 parts per weight of the compound selected from dodecanoic acid, metal dodecaonoate, ammonium dodecanoate, and a combination thereof;
(ii) 5 to 50 parts per weight of the compound selected from propionic acid, metal formate, metal propionate, ammonium propionate, and a combination thereof; and
(iii) optionally, a hydroxide selected from an alkali metal hydroxide, ammonium hydroxide, and a combination thereof;
wherein the pH of the antimicrobial composition is from 6 to 9.

14. The antimicrobial of claim 13, wherein the pH of the antimicrobial composition is from 7.5 to 9.

15. The antimicrobial composition of claim 12 comprising the metal dodecaonoate of (i), wherein the metal is selected from sodium, potassium, calcium, magnesium, and zinc.

16. The antimicrobial composition of claim 12 comprising the metal propionate of (ii), wherein the metal is selected from sodium, potassium, calcium, magnesium, and zinc.

17. The antimicrobial composition of claim 13, further comprising:
(iv) 0.005 to 0.1 parts per weight of a corrosion inhibitor selected from a metal metasilicate, zinc phosphate, calcium phosphate, and a combination thereof.

18. A water borne coating composition comprising:
(a) 0.3 to 3.0 wt. % of the antimicrobial combination of claim 12, based on the total weight of the water borne coating composition, and
(b) water,
wherein the waterborne coating composition is based on an emulsion polymer resin, and the emulsion polymer resin is based on a radical polymerization polymer selected from vinyl acetate (PVA) polymer, vinyl acetate/ethylene (VAE) copolymer, vinyl acrylic copolymer, acrylic polymer, styrene acrylic copolymer, vinyl acetate/ethylene/vinyl chloride copolymer, vinyl acetate versatate, and a combination thereof.

19. The water borne coating composition of claim 18 comprising 0.5 to 2.5 wt. % of the antimicrobial combination, based on the total weight of the water borne coating composition.

20. The water borne coating composition of claim 12 comprising 0.7 to 2.2 wt. % of the antimicrobial combination, based on the total weight of the water borne coating composition.

21. A method for preserving a water borne coating composition comprising adding the antimicrobial composition of claim 12 to the water borne coating composition.

22. The method of claim 21 comprising adding 0.1 to 3.0 wt. % of the antimicrobial composition to the water borne coating composition, based on the total weight of the water borne coating composition.

23. The method of claim 21 comprising adding 0.3 to 2.0 wt. % of the antimicrobial composition to the water borne coating composition, based on the total weight of the water borne coating composition.

24. The method of claim 21 comprising adding 0.5 to 2.5 wt. % of the antimicrobial composition to the water borne coating composition, based on the total weight of the water borne coating composition.

25. The method of claim 21 comprising adding 0.7 to 2.2 wt. % of the antimicrobial composition to the water borne coating composition, based on the total weight of the water borne coating composition.

26. The method of claim 21 comprising adding the antimicrobial composition to the water borne coating composition prior to adding pigments, rheologic modifiers, and dispersing agent to the water borne coating composition.

27. The method of claim 21, wherein the antimicrobial composition reduces microbial contamination and extends shelf life of the water borne coating composition.

28. The method of claim 21 comprising adding 0.1 to 3 wt. % of the antimicrobial composition to the water borne coating composition, based on the total weight of the water borne coating composition, before or during manufacture of the water borne coating composition, wherein the method reduces microbial contamination of processing equipment used during manufacture of the water borne coating composition.
